(19) United States
(12) Patent Application Publication
(10) Pub. No.: US 2026/0154762 A1
(43) Pub. Date: Jun. 4, 2026

(54) METHOD FOR REGULATING WIND-PHOTOVOLTAIC-STORAGE POWER STATION BASED ON ELECTRICITY, GREEN CERTIFICATE, AND CARBON PRICE PREDICTION, DEVICE, MEDIUM, AND PRODUCT

(71) Applicants: North China Electric Power University, Beijing (CN); NARI Technology Development Co., Ltd., Nanjing City (CN)

(72) Inventors: Nian LIU, Beijing (CN); Kai Jiang, Beijing (CN); Jie Huang, Nanjing City (CN); Zhen Wang, Nanjing City (CN); Lei Wang, Beijing (CN); Yangyang Liu, Beijing (CN)

(21) Appl. No.: 19/401,992

(22) Filed: Nov. 26, 2025

(30) Foreign Application Priority Data
Dec. 3, 2024 (CN) 202411757201.6

(51) Int. Cl. G06Q 50/06; G06N 3/0442; G06N 3/045; G06N 3/0464; G06Q 30/0201

(52) U.S. Cl. CPC G06Q 50/06; G06N 3/0442; G06N 3/045; G06N 3/0464; G06Q 30/0206

(57) ABSTRACT

Provided are a method for regulating a wind-photovoltaic-storage power station based on electricity, green certificate, and carbon price prediction, a device, a medium, and a product. The method includes: inputting acquired historical price data into a price prediction model, and outputting a predicted price; determining a deviation vector of price data based on the historical price data and the predicted price, and generating an uncertainty set of the predicted price by using a multi-kernel-based one-class support vector machine algorithm; classifying the uncertainty set of the predicted price by using a neural network classifier, to obtain multiple types of price scenarios; solving, based on predicted prices under the multiple types of price scenarios, a joint clearing model by using a Pied Kingfisher Optimization (PKO) algorithm, to obtain an operation strategy for the wind-photovoltaic-storage power station; and regulating the wind-photovoltaic-storage power station based on the operation strategy for the wind-photovoltaic-storage power station.

### CROSS REFERENCE TO RELATED APPLICATION

This patent application claims the benefit and priority of Chinese Patent Application No. 202411757201.6, filed with the China National Intellectual Property Administration on Dec. 3, 2024, the disclosure of which is incorporated by reference herein in its entirety as part of the present application.

### TECHNICAL FIELD

The present disclosure relates to the technical field of new energy power generation, and in particular, to a method for regulating a wind-photovoltaic-storage power station based on electricity, green certificate, and carbon price prediction, a device, a medium, and a product.

### BACKGROUND

With the accelerated advancement of the global energy transition, the proportion of new energy power generation is increasing year by year. To cope with the uncertainty of new energy power generation, power grid dispatch needs to be more flexible. In addition, multiple price factors such as electricity price, carbon price, and green certificate price affect the arrangement and implementation of dispatch plans for new energy power stations. Currently, electricity price, carbon price, and green certificate price all exhibit significant time series characteristics, possess complex long-term and short-term dependencies, and have considerable fluctuations and uncertainty. However, conventional prediction methods struggle to comprehensively capture these features, thereby affecting prediction accuracy. Meanwhile, under price fluctuations and uncertainty, how to quickly and efficiently obtain a fluctuation interval of price predictions and improve the robustness of a dispatch plan for wind-photovoltaic-storage power stations within this interval is a key issue that urgently needs to be solved.

### SUMMARY

An objective of the present disclosure is to provide a method for regulating a wind-photovoltaic-storage power station based on electricity, green certificate, and carbon price prediction, a device, a medium, and a product, to improve the prediction accuracy of electricity price, carbon price, and green certificate price, and enhance the robustness of the regulation of the wind-photovoltaic-storage power station.

To achieve the above objective, the present disclosure provides the following technical solutions.

According to a first aspect, the present disclosure provides a method for regulating a wind-photovoltaic-storage power station based on electricity, green certificate, and carbon price prediction, including: acquiring historical price data, where the historical price data includes: a historical carbon price, a historical green certificate price, and a historical electricity price;
inputting the historical price data into a price prediction model, and outputting a predicted price, where the predicted price includes: a carbon price prediction value, a green certificate price prediction value, and an electricity price prediction value; the price prediction model is obtained by training a hybrid attention mechanism-based Long Short-Term Memory (LSTM) neural network model using a training dataset; the training dataset includes sample price data and a corresponding prediction value of the sample price data;
determining a deviation vector of price data based on the historical price data and the predicted price;
generating, based on the deviation vector of the price data, an uncertainty set of the predicted price by using a multi-kernel (MKL)-based one-class support vector machine (OC-SVM) algorithm;
classifying the uncertainty set of the predicted price by using a neural network classifier, to obtain multiple types of price scenarios, where each type of price scenario includes a plurality of predicted prices;
solving, based on the predicted prices under the multiple types of price scenarios, a joint clearing model by using a Pied Kingfisher Optimization (PKO) algorithm, to obtain an operation strategy for the wind-photovoltaic-storage power station, where the joint clearing model includes a power generation strategy model for the wind-photovoltaic-storage power station, a power generation strategy model for a thermal power unit, a first objective function, and a first constraint condition; the power generation strategy model for the wind-photovoltaic-storage power station includes a second objective function and a second constraint condition; and the power generation strategy model for the thermal power unit includes a third objective function and a third constraint condition; and
regulating the wind-photovoltaic-storage power station based on the operation strategy for the wind-photovoltaic-storage power station.

According to a second aspect, the present disclosure provides a computer device, including a memory, a processor, and a computer program stored in the memory and executable on the processor, where the processor executes the computer program to perform the method for regulating a wind-photovoltaic-storage power station based on electricity, green certificate, and carbon price prediction described above.

According to a third aspect, the present disclosure provides a computer-readable storage medium storing a computer program, where the computer program, when executed by a processor, implements the method for regulating a wind-photovoltaic-storage power station based on electricity, green certificate, and carbon price prediction described above.

According to a fourth aspect, the present disclosure provides a computer program product, including a computer program, where the computer program, when executed by a processor, implements the method for regulating a wind-photovoltaic-storage power station based on electricity, green certificate, and carbon price prediction described above.

According to the specific embodiments provided in the present disclosure, the present disclosure has the following technical effects: the present disclosure provides a method for regulating a wind-photovoltaic-storage power station based on electricity, green certificate, and carbon price prediction, a device, a medium, and a product. A price prediction model is established to predict the carbon price, green certificate price, and electricity price, where the price prediction model is established based on an LSTM neural network model incorporating a hybrid attention mechanism, which can effectively capture the long-term and short-term dependencies of electricity price, carbon price, and green certificate price in time series data, thereby improving the accuracy of price prediction. An MKL-based OC-SVM algorithm is used to generate the uncertainty set of the predicted prices, thereby effectively handling outliers and noisy data, and improving the reliability of the uncertainty set. A neural network classifier is used to classify the uncertainty set of the predicted prices, improving the accuracy and stability of price scenario classification. Finally, the established joint clearing model under the multiple types of price scenarios, including the power generation strategy model for the wind-photovoltaic-storage power station and the power generation strategy model for the thermal power unit, can achieve benefit stability under price uncertainty and enable effective regulation of the operation of the wind-photovoltaic-storage power station.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a method for regulating a wind-photovoltaic-storage power station based on electricity, green certificate, and carbon price prediction according to an embodiment of the present disclosure;

FIG. 2 is another schematic flowchart of a method for regulating a wind-photovoltaic-storage power station based on electricity, green certificate, and carbon price prediction according to an embodiment of the present disclosure; and

FIG. 3 is a schematic structural diagram of a computer device according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

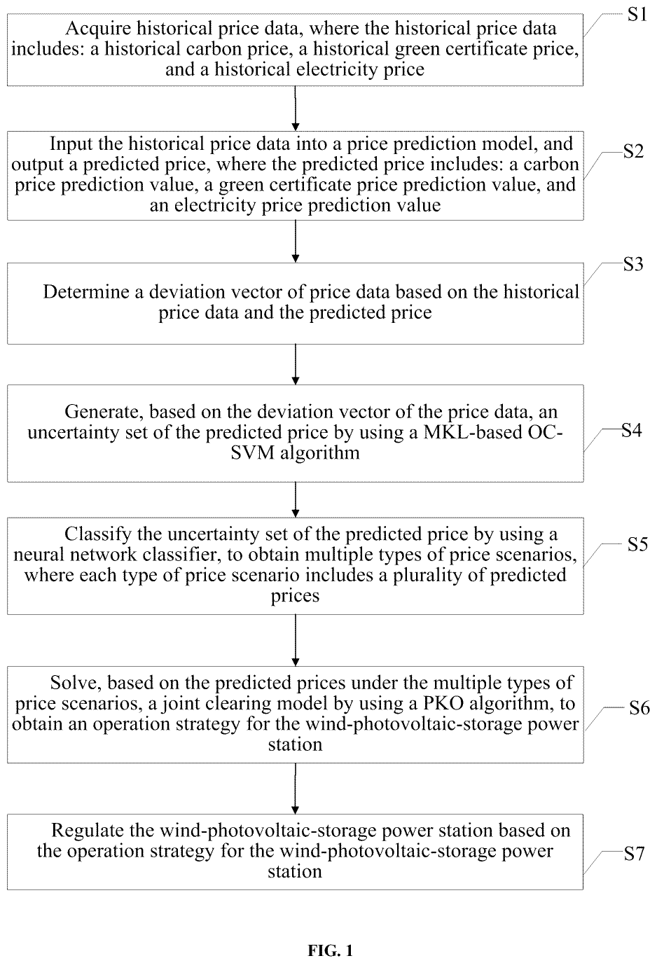

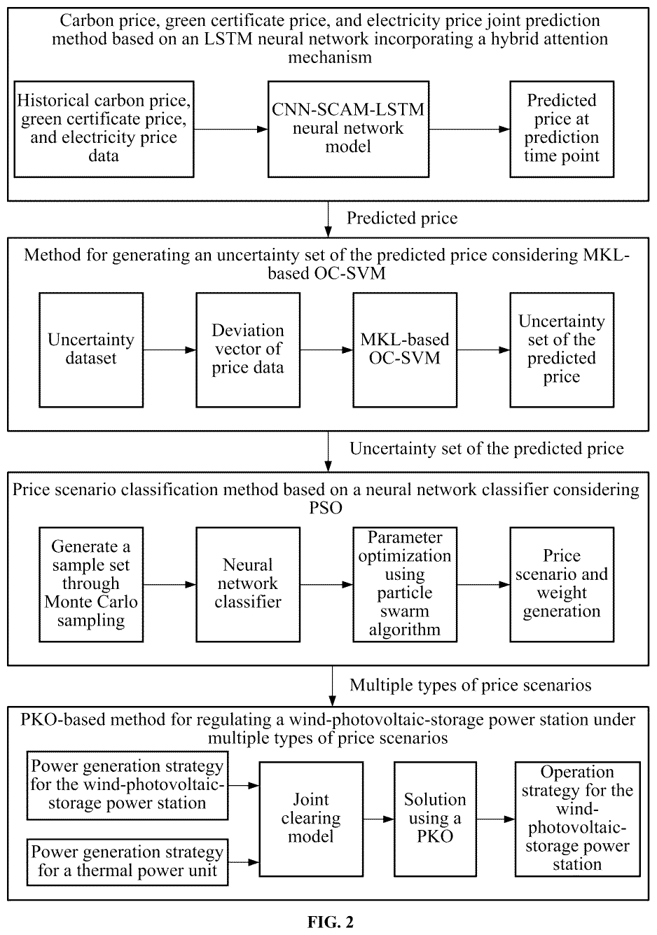

In an exemplary embodiment, as shown in FIG. 1 and FIG. 2, a method for regulating a wind-photovoltaic-storage power station based on electricity, green certificate, and carbon price prediction is provided, including steps S1 to S7.

Step S1: Acquire historical price data, where the historical price data includes: a historical carbon price, a historical green certificate price, and a historical electricity price. The carbon price is the price in the carbon trading market, the green certificate price is the price in the green certificate trading market, and the electricity price is the day-ahead electricity price in the spot electricity market.

Step S2: Input the historical price data into a price prediction model, and output a predicted price, where the predicted price includes: a carbon price prediction value, a green certificate price prediction value, and an electricity price prediction value; the price prediction model is obtained by training a hybrid attention mechanism-based LSTM neural network model using a training dataset; the training dataset includes sample price data and a corresponding prediction value of the sample price data. The sample price data is a price data at previous t time points, and the prediction value of the sample price data is a price data at a future prediction time point corresponding to the previous t time points; both are historical data.

Specifically, the historical price data are acquired on a daily basis, and each data includes hourly electricity prices within a day, a carbon price of that day, and a green certificate price of that day. That is, each set of data includes 26 data points; data from each quarter over multiple years constitute a training data subset; data from all quarters over the multiple years constitutes the training dataset, that is, the training dataset includes four training data subsets.

Step S3: Determine a deviation vector of price data based on the historical price data and the predicted price.

Step S4: Generate, based on the deviation vector of the price data, an uncertainty set of the predicted price by using an MKL-based OC-SVM algorithm.

Step S5: Classify the uncertainty set of the predicted price by using a neural network classifier, to obtain multiple types of price scenarios, where each type of price scenario includes a plurality of predicted prices.

Step S6: Solve, based on the predicted prices under the multiple types of price scenarios, a joint clearing model by using a PKO algorithm, to obtain an operation strategy for the wind-photovoltaic-storage power station, where the joint clearing model includes a power generation strategy model for the wind-photovoltaic-storage power station, a power generation strategy model for a thermal power unit, a first objective function, and a first constraint condition; the power generation strategy model for the wind-photovoltaic-storage power station includes a second objective function and a second constraint condition; and the power generation strategy model for the thermal power unit includes a third objective function and a third constraint condition.

Step S7: Regulate the wind-photovoltaic-storage power station based on the operation strategy for the wind-photovoltaic-storage power station.

In an optional implementation, in step S2, the hybrid attention mechanism-based LSTM neural network model includes a convolutional neural network (CNN), a sequential convolution attention module (SCAM), and an LSTM recurrent neural network connected sequentially.

Specifically, the structure of the hybrid attention mechanism-based LSTM neural network model includes: a CNN, a SCAM, and an LSTM recurrent neural network. The input is the historical price data at the t time points before the prediction time point, and the output is the electricity price prediction value, carbon price prediction value, and green certificate price prediction value at the prediction time point. Each type of price is a typical chaotic time series with significant time dependence. LSTM, as an excellent time feature extractor, can describe the changes in the time series more comprehensively. To further improve the feature extraction capability of the model, a CNN is introduced to extract features between data. Considering a large number of different input features, a SCAM is utilized to fuse feature mappings between different data.

In the CNN layer, the CNN is used for unified feature extraction, where the input is the price data at the previous t time points, and the output is a high-dimensional feature map. A ReLU activation function is applied between each convolutional layer and pooling layer, ignoring irrelevant features and improving the convergence speed of the model. The pooling layer uses a max-pooling method. A convolution process is as shown in the following formula.

$$\{ \begin{matrix}{I}_{0} = O \\ {I}_{ai} = {f}_{ReLU} ( {I}_{ai - 1} ⊗ {W}_{ai} + {b}_{ai} ) \\ {Q}_{ai} = max ( {I}_{ai} )\end{matrix} \qquad ( 1 )$$

where I₀ and O are original input; Iₐᵢ represents a feature output of an ai-th layer; f_{Re Lu} is a ReLU activation function; ⊗ is a convolution operation; Wₐᵢ is a weight vector of a convolutional kernel of the ai-th layer; bₐᵢ is a bias vector of the ai-th layer; Qₐᵢ is a feature output of a pooling layer of the ai-th layer, and max represents a max-pooling operation.

In the SCAM layer: For one-dimensional sequence prediction tasks requiring more precise numerical information, a hybrid attention model composed of two parts, a channel attention model (CAM) and a temporal attention module (TAM), is proposed, namely the sequential convolution attention module (SCAM). The CAM assigns weights to different feature mappings, automatically selecting the most meaningful input features for each task; the TAM concatenates the input features selected by the CAM along the time dimension, performs convolution kernel feature extraction, and then uses a Sigmoid function to obtain a temporal attention matrix, achieving weight allocation in the temporal dimension. The input of the SCAM layer is the high-dimensional feature map, capturing important features of the sequence from both channel and temporal dimensions, thereby avoiding the loss of key information; finally, features considering both channel and time series are output.

In the LSTM layer: the LSTM is a recurrent neural network used for processing sequences with specific temporal dependencies; the LSTM can effectively capture hidden temporal features. An LSTM unit includes three gate structures: an input gate, a forget gate, and an output gate. The gate structures collaboratively solve the problems of gradient vanishing and gradient explosion during training. A calculation method is as follows.

$$\{ \begin{matrix}{w}_{t} = ρ ( {W}_{w} [ {h}_{t - 1} , {x}_{t} ] + {b}_{w} ) \\ {g}_{t} = ρ ( {W}_{g} [ {h}_{t - 1} , {x}_{t} ] + {b}_{g} ) \\ {o}_{t} = ρ ( {W}_{o} [ {h}_{t - 1} , {x}_{t} ] + {b}_{o} )\end{matrix} \qquad ( 2 )$$

where ρ represents an LSTM-related operation function; wₜ, gₜ, and oₜ represent output features of the input gate, forget gate, and output gate at time t, respectively; W_{w}, W_{g}, and Wₒ are weight matrices; b_{w}, b_{g}, and bₒ are bias terms; xₜ and hₜ₋₁ are an input at the time t and an output at time t−1, respectively.

In an optional implementation, in step S2, a training process of the price prediction model specifically includes the following steps:

Step S21: Acquire a training dataset.

Step S22: Input the training dataset into the hybrid attention mechanism-based LSTM neural network model, and output the prediction value of the sample price data.

Step S23: Construct a loss function based on the prediction value of the sample price data and a true value of the sample price data, and iteratively optimize model parameters of the hybrid attention mechanism-based LSTM neural network model according to the loss function until an iteration count reaches a maximum value or the loss function reaches a minimum value, stop the iterative optimization, and obtain the price prediction model.

The training dataset is input into a four-channel CNN-SCAM-LSTM network model to complete training. After the training is completed, the historical price data at the t time points before the prediction time point is input into the CNN-SCAM-LSTM network model, and the predicted price at the prediction time point is output.

In an optional implementation, step S3 specifically includes the following steps:

Step S31: Acquire an uncertainty dataset; the uncertainty dataset includes multiple sets of data, each set of data is in a form consistent with the training dataset, a difference between the uncertainty dataset and the training dataset is that they are datasets from different time periods. For example, if the training dataset is data from 2022, the uncertainty dataset can be data from 2023.

Step S32: Input the multiple sets of data of the uncertainty dataset into the CNN-SCAM-LSTM neural network mode, to obtain a predicted price vector, and compare the predicted price vector with a true value (i.e., the corresponding historical price data) to obtain the deviation vector of the price data, where a calculation formula is as follows.

$${e}_{n , i}^{r a} = \frac{{y}_{n , i}^{fc} - {y}_{n , i}^{*}}{{y}_{n , i}^{*}} \qquad ( 3 )$$

where

$${e}_{n , i}^{ra}$$

is a deviation vector of i-th price data in an n-th group;

$${y}_{n , i}^{fc}$$

is a predicted price of the i-th price data in the n-th group; and

$${y}_{n , i}^{*}$$

is historical price data of the i-th price data in the n-th group.

In an optional implementation, in step S4, an expression of the uncertainty set of the predicted price is as follows.

$$U ( D ) = \{ v \vert {\sum }_{i = 1}^{N} {α}_{i}^{*} {\sum }_{m = 1}^{M} {ε}_{m}^{*} {K}_{m} ( v , {v}_{i} ) \geq {p}^{*} \} \qquad ( 4 )$$

where U(D) is the uncertainty set of the predicted price; v is an uncertainty vector of the predicted price; αᵢ* is an optimized value of an i-th dual variable in α; εₘ* is an optimized value of an m-th kernel function coefficient; Kₘ(v, vᵢ) is a value of an m-th kernel function between the uncertainty vector v of the predicted price and a sample vᵢ; and p*is an optimized value of a bias term. In the formula, vᵢ represents an i-th deviation vector in the uncertainty vector of the predicted price (i.e., the i-th sample).

Specifically, using the deviation vector of the price data as input data, and using multiple kernel functions, a method for generating the uncertainty set of the predicted price considering an MKL-based OC-SVM is proposed. An expression of the MKL-based OC-SVM is as follows.

$$\{ \begin{matrix}{min}_{\{ {H}_{m} \} , ε , p , χ} \frac{1}{2} {\sum }_{m = 1}^{M} {‖ {H}_{m} ‖}^{2} / {ε}_{m} - p + {\sum }_{i = 1}^{N} {χ}_{i} / {u}_{o} N \\ s . t . {\sum }_{m = 1}^{M} {H}_{m}^{T} φ ( {v}_{i} ) \geq p - {χ}_{i} , ∀ i \\ {χ}_{i} \geq 0 , ∀ i \\ {\sum }_{m = 1}^{M} {ε}_{m} = 1 , 0 \leq {ε}_{m} \leq \frac{1}{M \cdot {μ}_{0}}\end{matrix} \qquad ( 5 )$$

where M represents the number of basic kernel functions; Hₘ is a coefficient vector of support vectors; εₘ is a coefficient of each kernel function; p is a bias term; Xᵢ is a slack variable, allowing some points to deviate from a separating hyperplane; uₒ and μₒ are regularization parameters used to control the degree of slack in the model; N is the number of samples; φ(vᵢ) represents a feature mapping function from an input space to a high-dimensional feature space.

Further, a dual problem is obtained based on the strong duality theory. Assuming all the kernel functions are positive semi-definite, the dual problem is also convex and can be solved using a general convex optimization solver.

$$\{ \begin{matrix}{min}_{a , γ , λ} - γ + \frac{1}{M \cdot {μ}_{0}} {\sum }_{m = 1}^{M} {λ}_{m} \\ s . t . - \frac{1}{2} {\sum }_{i , j = 1}^{N} {α}_{i} {α}_{j} {K}_{m} ( {v}_{i} , {v}_{j} ) \geq γ - {λ}_{m} , ∀ m \\ {λ}_{m} \geq 0 , ∀ m \\ {\sum }_{i = 1}^{N} {α}_{i} = 1 , 0 \leq {α}_{i} \leq \frac{1}{N \cdot {u}_{o}}\end{matrix} \qquad ( 6 )$$

where α, γ, and λ are dual variables corresponding to constraints of the primal problem; Kₘ(vᵢ, vⱼ) is a value of an m-th kernel function between sample vᵢ and sample vⱼ; αᵢ and αⱼ are an i-th and a j-th dual variables in α, respectively.

The solutions to the primal problem (formula (5)) and the dual problem (formula (6)) are

$$\{ \{ {H}_{m}^{*} \} , {ε}^{*} , {p}^{*} , {χ}^{*} \}$$

and {α, γ, λ}, respectively; using the solution results, the uncertainty set is expressed as formula (4).

In an optional implementation, step S5 specifically includes the following steps:

Step S51: Based on the uncertainty set of the predicted price in step S4, obtain a sample set through Monte Carlo sampling, to serve as input data for the neural network classifier.

Step S52: Classify the sample set by using the neural network classifier, to obtain multiple types of price scenarios, where the neural network classifier considers particle swarm optimization (PSO). Because an operation strategy (output situation) of the wind-photovoltaic-storage power station needs to be formulated based on price data, different price data will lead to different strategies. Due to the uncertainty and diversity of predicted prices, multiple types of price scenarios are used for characterization, that is, one type of price scenario represents one type of predicted price data.

The price scenario is an arithmetic mean under price data samples. Based on a classification result, multiple types of price scenarios can be obtained. First, a sample subclass of predicted price data is first calculated based on a predicted price at a prediction time point and a deviation value of the sample subclass. Then, an arithmetic mean of the sample subclass of the predicted price data is calculated to obtain a price scenario under the sample subclass, as shown in formula (7), and a price scenario weight is defined as shown in formula (8).

$${y}_{x , i}^{ra} = \frac{1}{{N}_{x}} {\sum }_{n = 1}^{{N}_{x}} \frac{{y}_{i}^{fc}}{( 1 + {e}_{x , n , i}^{ra} )} \qquad ( 7 )$$

$${ξ}_{x} = \frac{{N}_{x}}{{\sum }_{∀ x} {N}_{x}} \qquad ( 8 )$$

where

$${e}_{x , n , i}^{r a}$$

is a deviation value of i-th price data in a n-th group under x k-th type of price scenario;

$${y}_{x , i}^{r a}$$

is an average predicted value of the i-th price data under the x-th type of price scenario;

$${y}_{i}^{fc}$$

is a predicted price value or the i-th price data; Nₓ is the number of data groups under the x-th type of price scenario; and ξₓ is a weight of the x-th type of price scenario.

Further, a specific process for constructing the neural network classifier considering PSO is as follows.

The neural network classifier includes three parts: an input layer, a hidden layer, and an output layer. In the hidden layer of the neural network classifier, fuzzy c-means (FCM) clustering is used to calculate a fitness value, and least squares estimation (LSE) is used to calculate connection weight coefficients. In the output layer of the neural network classifier, an output value of the classifier is calculated through fuzzy inference. Fuzzy inference is a process of mapping given input data to output data using membership functions, logical operators, and If-Then rules.

In the premise part of the fuzzy rules, FCM clustering is used to group the data. FCM clustering is used in data analysis to find a centroid point and a membership degree of each cluster. The FCM clustering algorithm consists of the following steps.

1. Determine the number of clusters, and initialize a membership matrix U^{r}.

$${U}^{r} = \{ {u}_{c i , c j} ∈ [ 0 , 1 ] , {\sum }_{ci = 1}^{CI} {u}_{c i , c j} = 1 , ∀ cj , {\sum }_{cj = 1}^{CJ} {u}_{c i , c j} < C J , ∀ c i \} \qquad ( 9 )$$

where u_{ci,cj} represents a membership degree of sample x_{cj} belonging to cluster ci, CI is the total number of clusters, and CJ is the total number of samples.

2. Calculate a centroid point for each cluster.

$$c {v}_{c i} = \frac{{\sum }_{Cj = 1}^{CJ} {u}_{ci , cj}^{F C} {x}_{c j}}{{\sum }_{cj = 1}^{CJ} {u}_{ci , cj}^{FC}} \qquad ( 10 )$$

where cv_{ci} is a centroid of cluster ci, and FC represents a fuzziness parameter.

3. Update the membership matrix using a Euclidean distance function.

$${U}^{r + 1} = \frac{1}{{\sum }_{cp = 1}^{CI} {( \frac{{d}_{ci , cj}^{r}}{{d}_{cp , cj}^{r}} )}^{\frac{2}{FC - 1}}} {d}_{ci , cj} = ‖ {x}_{cj} - {v}_{ci} ‖ \qquad ( 11 )$$

where ∥x_{cj}−v_{ci}∥ is a Euclidean distance from

$${x}_{cj} to {v}_{ci} ; {d}_{ci , cj}^{r} , {d}_{cp , cj}^{r} ,$$

are Euclidean distances from the sample to the cluster centroids; and U^{r+1} is a membership matrix at an (r+1)-th iteration.

4. Check a termination condition. If the following condition is met, the iteration is terminated; otherwise, the process returns to step 2 to continue the iteration.

$$‖ {U}^{r + 1} - {U}^{r} ‖ \leq {δ}_{u} \qquad ( 12 )$$

where δᵤ is a preset threshold used to determine whether the algorithm has converged.

In the inference part of the fuzzy rules, LSE is used to estimate the connection weight coefficients. LSE is a global learning algorithm that minimizes an overall squared error between a model output and a target output. A mean squared error (MSE) is used as an objective function for LSE.

$$\begin{matrix}{Q}_{LSE} = {\sum }_{k = 1}^{KL} {\sum }_{cj = 1}^{CJ} {[ {y}_{cj}^{k} - {\sum }_{ci = 1}^{CI} {u}_{ci , cj} {f}_{ci} ( {x}_{cj} ) ]}^{2} \\ = {( {Y}^{k} - {XA}^{k} )}^{T} ( {Y}^{k} - {A}^{k} X )\end{matrix} \qquad ( 13 )$$

where f_{ci} (x_{cj}) is an output value of cluster ci under

$${x}_{cj} ; {y}_{cj}^{k}$$

output; KL is a constant; A^{k} is a connection weight coefficient; X is an input data matrix; and Y is a target output matrix.

A resulting value of the connection weight coefficient is determined by the following formula.

$${A}^{k} = {( {X}^{T} X )}^{- 1} {X}^{T} {Y}^{k} \qquad ( 14 )$$

Further, PSO is used to optimize parameters of the neural network classifier. The parameters optimized by PSO are related to three factors: the number of fuzzy rules used in the fuzzy c-means clustering, the value of the fuzziness parameter, and a polynomial type of connection weights. The process of PSO for the parameters of the neural network classifier is as follows.

1. Randomly generate a particle swarm Ja, a particle position pa, and a particle velocity va.

$$Ja ( g ) = {[ {va}_{1} ( g ) , {va}_{2} ( g ) , … , {va}_{b} ( g ) ]}^{T} \qquad ( 15 )$$

where b represents the number of parameters that need to be optimized, i.e., the number of particles; and g represents the current iteration number of the PSO execution.

2. Adjust an inertia weight ra.

$$ra ( g ) = {ra}_{max} - \frac{{ra}_{max} - {ra}_{min}}{{g}_{max}} \times g \qquad ( 16 )$$

where raₘₐₓ and raₘᵢₙ represent a maximum value and a minimum value of the inertia weight, respectively; gₘₐₓ represents a maximum number of iterations; and ra(g) is an inertia weight at a g-th iteration.

3. Update particles: Adjust the particle velocity va by using values of pa_{bt} (g) and qa_{bt} (g).

$$va ( g + 1 ) = ra ( g ) va ( g ) + {c}_{1} {e}_{1} [ {pa}_{bt} ( g ) - pa ( g ) ] + {c}_{2} {e}_{2} [ {qa}_{bt} ( g ) - pa ( g ) ] \qquad ( 17 )$$

where va(g) and va(g+1) are particle velocities at g-th and g+1-th iterations, respectively; c₁ and c₂ are acceleration constants; e₁ and e₂ are random values between 0 and 1; pa_{bt} (g) is an optimal position of a particle at the g-th iteration; qa_{bt} (g) is a global optimal position at the g-th iteration; pa(g) is an attractor of the particle at the g-th iteration, representing the ability of the particle to attract other particles closer.

4. Update the position of each particle using the updated velocity, evaluate the updated particles using an objective function, and compare particle performance in pa_{bt} (g) and qa_{bt} (g).

$$pa ( g + 1 ) = pa ( g ) + va ( g + 1 ) \qquad ( 18 )$$

where pa(g+1) is an attractor of the particle at the g+1-th iteration.

5. If a termination condition is not met, repeat steps 2 to 4.

The above process is interpreted as follows: the particle structure corresponds to the parameters that need to be optimized; the parameters are determined by the particles, and selectable parameters are as follows.

$$\{ \begin{matrix}{z}_{1} ∈ \{ 2 , 3 , 4 , 5 \} \\ {z}_{3} = \{ \begin{matrix}1 , & type = Constant \\ 2 , & type = Linear\end{matrix} \\ {z}_{2} = FC\end{matrix} \qquad ( 19 )$$

where z₁ is the number of fuzzy rules; z₂ and FC are values of the fuzziness parameter; z₃ is a polynomial type of connection weights; Constant represents a constant; and Linear represents a linear expression.

Based on the PSO results, selected parameters are used to construct the neural network classifier.

In an optional implementation, in step S6, based on the power generation strategies of the wind-photovoltaic-storage power station and the thermal power unit, a joint clearing model is established. A corresponding objective function is the first objective function, and an expression of the first objective function is as follows.

$$min {\sum }_{∀ k , ∀ t} ( {λ}_{k , t}^{A} {p}_{k , t}^{A} + {λ}_{k , t}^{G} {p}_{k , t}^{G} ) \qquad ( 20 )$$

where

$${λ}_{k , t}^{A}$$

is a quotation of a k-th segment of the wind-photovoltaic-storage power station at the time t;

$${p}_{k , t}^{A}$$

is an output active power of the k-th segment of the wind-photovoltaic-storage power station at the time t;

$${λ}_{k , t}^{G}$$

is a quotation or a k-th segment of the thermal power unit at the time t; and

$${p}_{k , t}^{G}$$

is an output active power or the k-th segment of the thermal power unit at the time t.

In the joint clearing model, in addition to the power generation strategy constraints of the wind-photovoltaic-storage power station and the thermal power unit, the electrical load demand needs to be met; therefore, a power balance constraint is considered. The corresponding first constraint condition is as follows.

$${\sum }_{∀ g} {p}_{g , t} + {\sum }_{∀ w} {p}_{w , t} + {\sum }_{∀ p v} {p}_{pv , t} + {\sum }_{∀ e s s} ( {p}_{e ss , t}^{out} - {p}_{ess , t}^{i n} ) = {\sum }_{∀ l} {p}_{l , t} \qquad ( 21 )$$

where p_{g,t} is an actual output of the thermal power unit at the time t; p_{w,t} is an output active power of a wind turbine unit at the time t; p_{pv,t} is an output active power of a photovoltaic unit at the time t;

$${p}_{e ss , t}^{out}$$

is a discharge power of an electrochemical energy storage system;

$${p}_{ess , t}^{i n}$$

is a charging power of the electrochemical energy storage system; and p_{l,t} is an electrical load demand.

During establishment of the power generation strategy model for the wind-photovoltaic-storage power station, based on predicted prices under multiple types of price scenarios, the power generation strategy model for the wind-photovoltaic-storage power station aims to maximize the profit of the wind-photovoltaic-storage power station and formulates a power generation strategy. The corresponding objective function is the second objective function. An expression of the second objective function is as follows.

$$max [ \begin{matrix}{\sum }_{∀ t , ∀ x} {ξ}_{x} ( {\sum }_{k} {p}_{k , t}^{A} ( {λ}_{t , x}^{e} - {λ}_{k , t}^{A} ) ) Δ t + \\ {\sum }_{∀ x} {ξ}_{x} {λ}_{x}^{g} ( {\sum }_{∀ t} {a}_{w , t} {p}_{w , t} + {\sum }_{∀ t} {a}_{pv , t} {p}_{pv , t} ) Δ t\end{matrix} ] \qquad ( 22 )$$

where ξₓ is a weight of an x-th type of price scenario;

$${λ}_{t , x}^{e}$$

is an electricity price at time t under the x-th type of price scenario;

$${λ}_{x}^{g}$$

is a green certificate price under the x-th type of price scenario; a_{w,t} is a green certificate allocation coefficient of the wind turbine unit; and a_{pv,t} is a green certificate allocation coefficient of the photovoltaic unit.

The second constraint condition corresponding to the power generation constraints of the wind-photovoltaic-storage power station is as follows.

$$\{ \begin{matrix}0 \leq {p}_{pv , t} \leq {p}_{pv , t}^{ipre} \leq {P}_{pv , t}^{N} \\ 0 \leq {p}_{w , t} \leq {p}_{w , t}^{ipre} \leq {P}_{w , t}^{N}\end{matrix} \qquad ( 23 )$$

$$\{ \begin{matrix}{P}_{e s s , m i n} \leq {P}_{ess , t}^{i n} , {P}_{ess , t}^{out} \leq {P}_{e s s , m ax} \\ {P}_{ess , t}^{out} \times {P}_{ess , t}^{i n} = 0 \\ \begin{matrix}{SoC}_{ess , t} = {SoC}_{ess , t - 1} + \frac{[ {η}_{ess , i n} {P}_{ess , t}^{i n} - {P}_{ess , t}^{out} / {η}_{ess , out} ]}{{E}_{ess}^{N}} \\ {SoC}_{ess , m i n} \leq {SoC}_{ess , t} \leq {SoC}_{ess , m ax}\end{matrix}\end{matrix} \qquad ( 24 )$$

where

$${p}_{pv , t}^{ipre}$$

is a predicted output of the photovoltaic unit at the time t;

$${P}_{pv , t}^{N}$$

is an installed capacity of the photovoltaic unit at the time t;

$${p}_{w , t}^{ipre}$$

is a predicted output or the wind turbine unit at the time t; and

$${P}_{w , t}^{N}$$

is an installed capacity of the wind turbine unit at the time t; P_{ess,min} is a minimum charging/discharging power of the electrochemical energy storage system; P_{ess,max} is a maximum charging/discharging power of the electrochemical energy storage system; SoC_{ess,t} is a state of charge of the electrochemical energy storage system; SoC_{ess,min} is a lower limit of the state of charge of the electrochemical energy storage system; SoC_{ess,max} is an upper limit of the state of charge of the electrochemical energy storage system; η_{ess,in} is charging efficiency of the electrochemical energy storage system; η_{ess,out} is discharging efficiency of the electrochemical energy storage system;

$${E}_{e s s}^{N}$$

is rated energy of the electrochemical energy storage system.

During establishment of the power generation strategy model for the thermal power unit, based on the predicted prices under multiple types of price scenarios, and using a thermal power unit cost and carbon emission factor as a benchmark, a power generation strategy for the thermal power unit is formulated. The corresponding objective function is the third objective function. An expression of the third objective function is as follows.

$$max [ {\sum }_{∀ t , ∀ x} {ξ}_{x} ( {\sum }_{∀ k} {p}_{k , t}^{G} ( {λ}_{t , x}^{e} - {λ}_{k , t}^{G} ) ) Δ t + {\sum }_{∀ x} {ξ}_{x} {λ}_{x}^{c o} ( {X}^{z i} - {\sum }_{∀ t} {b}_{g , t} {p}_{g , t} ) Δ t ] \qquad ( 25 )$$

$${b}_{g , t} = \{ \begin{matrix}{b}_{coal , t} , {p}_{g}^{m i n} \leq {p}_{g , t} \leq {p}_{g}^{m ax} \\ {b}_{coal , t} + {b}_{loss , t} , {p}_{g}^{A} \leq {p}_{g , t} \leq {p}_{g}^{m i n} \\ {b}_{coal , t} + {b}_{loss , t} + {b}_{oil , t} , {p}_{g}^{B} \leq {p}_{g , t} \leq {p}_{g}^{A}\end{matrix} \qquad ( 26 )$$

where

$${λ}_{x}^{c o}$$

is a carbon price under the x-th type of price scenario; X^{zi} is an initial carbon quota within a dispatch period; b_{g,t} is a total carbon emission factor of the thermal power unit at the time t; b_{coal,t} is a coal consumption carbon emission factor of the thermal power unit at the time t; b_{loss,t} is a loss carbon emission factor of the thermal power unit at the time t; b_{oil,t} is an oil injection carbon emission factor of the thermal power unit at the time t;

$${p}_{g}^{min}$$

is a lower limit output of the thermal power unit in a normal peak shaving stage,

$${p}_{g}^{ma x}$$

an upper limit output of the thermal power unit in the normal peak shaving stage,

$${p}_{g}^{A}$$

is a lower limit output of the thermal power unit in a stage of peak shaving through speed reduction; and

$${p}_{g}^{B}$$

is a lower mint output of the thermal power unit in a stage of peak shaving with oil injection;

A deep peak shaving model of the thermal power unit is as follows.

$${C}_{g , t} = \{ \begin{matrix}{C}_{coal , t} , {p}_{g}^{min} \leq {p}_{g , t} \leq {p}_{g}^{ma x} \\ {C}_{coal , t} + {C}_{loss , t} , {p}_{g}^{A} \leq {p}_{g , t} \leq {p}_{g}^{min} \\ {C}_{coal , t} + {C}_{loss , t} + {C}_{oil , t} , {p}_{g}^{B} \leq {p}_{g , t} \leq {p}_{g}^{A}\end{matrix} \qquad ( 27 )$$

where C_{g,t} is a total cost of the thermal power unit at the time t; C_{coal,t} is a coal consumption cost of the thermal power unit at the time t; C_{loss,t} is a loss cost of the thermal power unit at the time t; and C_{oil,t} is an oil injection cost of the thermal power unit at the time t; p_{g,t} is an actual output of the thermal power unit at the time t.

Binary variables are introduced to linearize segmented constraints, and the total cost C_{g,t} of the thermal power unit is expressed as follows.

$${C}_{g , t} = {C}_{g , t}^{coal} + {u}_{g , t}^{loss} {C}_{g , t}^{loss} + {u}_{g , t}^{oil} {C}_{g , t}^{oil} \qquad ( 28 )$$

$${u}_{g , t}^{loss} = \{ \begin{matrix}0 , & {p}_{g}^{min} \leq {p}_{g , t} \leq {p}_{g}^{ma x} \\ 1 , & {p}_{g}^{B} \leq {p}_{g , t} \leq {p}_{g}^{min}\end{matrix} \qquad ( 29 )$$

$${u}_{g , t}^{oil} = \{ \begin{matrix}0 , & {p}_{g}^{A} \leq {p}_{g , t} \leq {p}_{g}^{ma x} \\ 1 , & {p}_{g}^{B} \leq {p}_{g , t} \leq {p}_{g}^{A}\end{matrix} \qquad ( 30 )$$

where

$${u}_{g , t}^{oil} and {u}_{g , t}^{loss}$$

are binary variables representing the stage of peak shaving with oil injection and the stage of peak shaving through speed reduction, respectively.

Consumption characteristics and energy cost characteristics of the thermal power unit can be expressed as piecewise functions divided based on the peak shaving stages. Since carbon emissions of the unit have a strong positive correlation with the coal consumption, the carbon emissions can also be divided based on the peak shaving stages of the unit. Specific expressions are shown in formula (26).

Deep peak shaving of the thermal power unit needs to satisfy ramp constraints and technical output constraints, which are taken as the third constraint condition. The third constraint condition is as follows.

$$\{ \begin{matrix}{P}_{g}^{min} \leq {P}_{g , t} \leq {P}_{g}^{max} \\ {P}_{g , t} - {P}_{g , t - 1} \leq {P}_{g}^{up} \\ {p}_{{g}_{,} t - 1} - {p}_{g , t} \leq {P}_{g}^{down}\end{matrix} \qquad ( 31 )$$

where

$${P}_{g}^{min}$$

is a minimum technical output of the thermal power unit

$${P}_{g}^{max}$$

is a maximum technical output of the thermal power unit;

$${P}_{g}^{up}$$

is an upward ramp power limit of the thermal power unit; and

$${P}_{g}^{down}$$

is a downward ramp power limit of the thermal power unit.

In an optional implementation, in step S6, the PKO algorithm is used to solve the aforementioned joint clearing model that considers the power generation strategies of the wind-photovoltaic-storage power station and the thermal power unit. Finally, after solving, the operation strategy of the wind-photovoltaic-storage power station (i.e., the output of the wind-photovoltaic-storage power station at each time) can be obtained.

The PKO algorithm combines three foraging operations to simulate the foraging strategy of the pied kingfisher, including a perching and hovering stage, a diving stage, and a commensalism stage. It can effectively solve various optimization problems in different search spaces and meet computational accuracy requirements with relatively low computational cost. The three strategies of PKO are shown below, and the algorithm optimization process is as follows.

First, the population is initialized by randomly generating a set of initial solutions from the search space as the first trial to start the search process. Secondly, a random number is generated. The pied kingfisher will choose between the perching and hovering stage, i.e., formula (32), and the diving stage, i.e., formula (33), to update the position of the model solution. Further, the pied kingfisher enters the commensalism stage, i.e., formula (34). After the position is updated, an objective fitness value of the updated position Xₙ (t+1) is evaluated. If the updated position is better than the current best position X_{best} (t), the current best position is replaced with the updated position. Finally, iteration is performed continuously until a set maximum number of iterations is reached, and the best position result is outputted to serve as the optimal solution.

$${X}_{n} ( t + 1 ) = {X}_{n} ( t ) + {α}_{p k o} {L}_{p k o} \times ( {X}_{m} ( t ) - {X}_{n} ( t ) ) , m \neq n , m , n ∈ \{ 1 , 2 , … , {N}_{p k o} \} \qquad ( 32 )$$

$${X}_{n} ( t + 1 ) = {X}_{n} ( t ) + DS * {o}_{p k o} * {α}_{p k o} * ( {b}_{p k o} - {X}_{best} ( t ) ) , n ∈ \{ 1 , 2 , … , {N}_{p k o} \} \qquad ( 33 )$$

$${X}_{n} ( t + 1 ) = \{ \begin{matrix}{X}_{r 1} ( t ) + {o}_{p k o} * {α}_{p k o} * abs ( {X}_{n} ( t ) - {X}_{r 2} ( t ) ) if rand > ( 1 - PE ) \\ {X}_{n} ( t ) otherwise\end{matrix} \qquad ( 34 )$$

where Xₙ (t) and Xₙ (t+1) are positions of an n-th individual at a t-th iteration and a (t+1)-th iteration, respectively; Xₘ (t) is a position of an m-th individual at the t-th iteration; αₚₖₒ is a random parameter; Nₚₖₒ is a population size; Lₚₖₒ is a dynamic parameter related to perching and hovering behavior; oₚₖₒ and DS are control parameters representing hunting ability, and are position parameters related to oₚₖₒ and X_{best} (t); Xᵣ₁(t) and Xᵣ₂(t) are two individuals randomly selected from the population; PE is a predation efficiency parameter; and rand is a random number between 0 and 1.

The present disclosure has the following beneficial effects.

(1) A neural network model integrating CNN-SCAM-LSTM is established, which possesses excellent time feature extraction capability, can comprehensively describe changes in time series, effectively capture long-term and short-term dependencies of electricity price, carbon price, and green certificate price in time series data, and improve the prediction accuracy of price prediction tasks.

(2) Multiple kernel functions are used, to adapt to the distribution and features of different prediction data, and an uncertainty set of the predicted price based on a MKL-based OC-SVM is proposed, which effectively handles outliers and noisy data and improves the reliability of the uncertainty set.

(3) For the neural network classifier used for dataset classification, a PSO algorithm is used to optimize the parameters of the neural network, thereby reducing neural network training time, improving efficiency, and significantly enhancing the accuracy and stability of price scenario classification.

(4) A power generation strategy model for the wind-photovoltaic-storage power station under multiple types of price scenarios is established, which can achieve benefit stability under price uncertainty, avoid excessive losses, and achieve excellent robustness. Meanwhile, the PKO algorithm is used to solve the joint clearing model, which can effectively solve various optimization problems in different search spaces and meet computational accuracy requirements with relatively low computational cost.

In an exemplary embodiment, a computer device is provided, including a memory, a processor, and a computer program stored in the memory and executable on the processor, where the processor executes the method for regulating a wind-photovoltaic-storage power station based on electricity, green certificate, and carbon price prediction.

In an exemplary embodiment, a computer-readable storage medium is provided. The computer-readable storage medium stores a computer program, and the computer program, when executed by a processor, implements the method for regulating a wind-photovoltaic-storage power station based on electricity, green certificate, and carbon price prediction.

In an exemplary embodiment, a computer program product is provided, including a computer program. The computer program, when executed by a processor, implements the method for regulating a wind-photovoltaic-storage power station based on electricity, green certificate, and carbon price prediction.

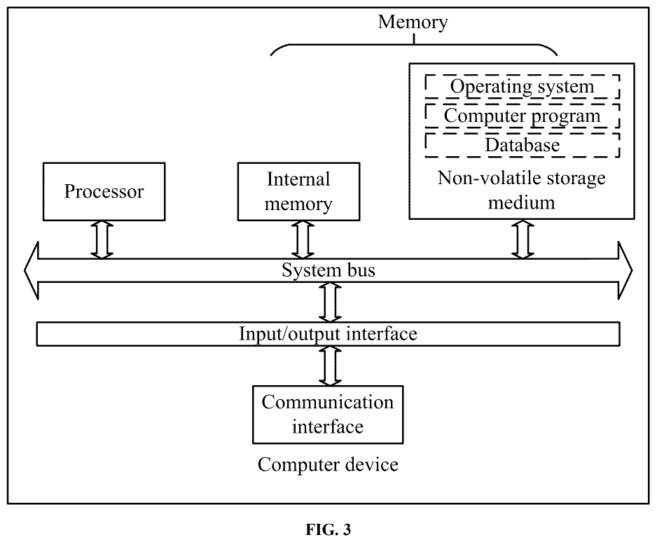

In an exemplary embodiment, a computer device is provided. The computer device may be a server or a terminal, and an internal structure thereof may be as shown in FIG. 3. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer apparatus includes a nonvolatile storage medium, and an internal memory. The non-volatile storage medium stores an operating system, a computer program, and a database. The internal memory provides an environment for operations of the operating system and the computer program in the non-volatile storage medium. The input/output interface of the computer apparatus is configured to exchange information between the processor and an external apparatus. The communication interface of the computer apparatus is configured to communicate with an external terminal through a network. The computer program, when executed by a processor, implements a method for regulating a wind-photovoltaic-storage power station based on electricity, green certificate, and carbon price prediction.

Those skilled in the art may understand that the structure shown in FIG. 3 is only a block diagram of a part of the structure related to the solution of the present disclosure and does not constitute a limitation on a computer device to which the solution of the present disclosure is applied. Specifically, the computer device may include more or less components than those shown in the figure, or combine some components, or have different component arrangements.

It is to be noted that the information of a user (including but not limited to device information of the user, personal information of the user and the like) and data (including but not limited to data for analysis, data for storage, data for exhibition and the like) in the present disclosure are information and data authorized by the user or fully authorized by each party, and the information and data are acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing examples is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

What is claimed is:

1. A method for regulating a wind-photovoltaic-storage power station based on electricity, green certificate, and carbon price prediction, comprising:
acquiring historical price data, wherein the historical price data comprises: a historical carbon price, a historical green certificate price, and a historical electricity price;
inputting the historical price data into a price prediction model, and outputting a predicted price, wherein the predicted price comprises: a carbon price prediction value, a green certificate price prediction value, and an electricity price prediction value; the price prediction model is obtained by training a hybrid attention mechanism-based Long Short-Term Memory (LSTM) neural network model using a training dataset; the training dataset comprises sample price data and a corresponding prediction value of the sample price data;
determining a deviation vector of price data based on the historical price data and the predicted price;
generating, based on the deviation vector of the price data, an uncertainty set of the predicted price by using a multi-kernel (MKL)-based one-class support vector machine (OC-SVM) algorithm;
classifying the uncertainty set of the predicted price by using a neural network classifier, to obtain multiple types of price scenarios, wherein each type of price scenario comprises a plurality of predicted prices;
solving, based on the predicted prices under the multiple types of price scenarios, a joint clearing model by using a Pied Kingfisher Optimization (PKO) algorithm, to obtain an operation strategy for the wind-photovoltaic-storage power station, wherein the joint clearing model comprises a power generation strategy model for the wind-photovoltaic-storage power station, a power generation strategy model for a thermal power unit, a first objective function, and a first constraint condition; the power generation strategy model for the wind-photovoltaic-storage power station comprises a second objective function and a second constraint condition; and the power generation strategy model for the thermal power unit comprises a third objective function and a third constraint condition; and
regulating the wind-photovoltaic-storage power station based on the operation strategy for the wind-photovoltaic-storage power station.

2. The method for regulating a wind-photovoltaic-storage power station based on electricity, green certificate, and carbon price prediction according to claim 1, wherein the hybrid attention mechanism-based LSTM neural network model comprises a convolutional neural network, a sequential convolution attention module (SCAM), and an LSTM recurrent neural network that are connected sequentially.

3. The method for regulating a wind-photovoltaic-storage power station based on electricity, green certificate, and carbon price prediction according to claim 2, wherein a training process of the price prediction model comprises:
acquiring a training dataset;
inputting the training dataset into the hybrid attention mechanism-based LSTM neural network model, and outputting the prediction value of the sample price data; and
constructing a loss function based on the prediction value of the sample price data and a true value of the sample price data, and iteratively optimizing model parameters of the hybrid attention mechanism-based LSTM neural network model according to the loss function until an iteration count reaches a maximum value or the loss function reaches a minimum value, stopping the iterative optimization, and obtaining the price prediction model.

4. The method for regulating a wind-photovoltaic-storage power station based on electricity, green certificate, and carbon price prediction according to claim 1, wherein an expression of the uncertainty set of the predicted price is:
$$U ( D ) = \{ v \vert {\sum }_{i = 1}^{N} {α}_{i}^{*} {\sum }_{m = 1}^{M} {ε}_{m}^{*} {K}_{m} ( v , {v}_{i} ) \geq {p}^{*} \}$$
wherein U(D) is the uncertainty set of the predicted price; v is an uncertainty vector of the predicted price; αᵢ* is an optimized value of an i-th dual variable in α; εₘ* is an optimized value of an m-th kernel function coefficient; Kₘ (v, vᵢ) is a value of an m-th kernel function between the uncertainty vector v of the predicted price and a sample vᵢ; and p* is an optimized value of a bias term.

5. The method for regulating a wind-photovoltaic-storage power station based on electricity, green certificate, and carbon price prediction according to claim 1, wherein an expression of the first objective function is:
$$min {\sum }_{∀ k , ∀ t} ( {λ}_{k , t}^{A} {p}_{k , t}^{A} + {λ}_{k , t}^{G} {p}_{k , t}^{G} )$$
wherein
$${λ}_{k , t}^{A}$$
is a quotation or a k-un segment of the wind-photovoltaic-storage power station at time t;
$${p}_{k , t}^{A}$$
is an output active power of the k-th segment of the wind-photovoltaic-storage power station at the time t;
$${λ}_{k , t}^{G}$$
is a quotation of a k-th segment of the thermal power unit at the time t; and
$${p}_{k , t}^{G}$$
is an output active power of the k-th segment of the thermal power unit at the time t;
the first constraint condition is:
$${\sum }_{∀ g} {p}_{g , t} + {\sum }_{∀ w} {p}_{w , t} + {\sum }_{∀ p v} {p}_{pv , t} + {\sum }_{∀ e s s} ( {p}_{e ss , t}^{out} - {p}_{ess , t}^{i n} ) = {\sum }_{∀ l} {p}_{l , t}$$
wherein p_{g,t} is an actual output of the thermal power unit at the time t; p_{w,t} is an output active power of a wind turbine unit at the time t; p_{pv,t} is an output active power of a photovoltaic unit at the time t;
$${p}_{e ss , t}^{out}$$
is a discharge power of an electrochemical energy storage system;
$${p}_{ess , t}^{i n}$$
is a charging power of the electrochemical energy storage system; and p_{l,t} is an electrical load demand.

6. The method for regulating a wind-photovoltaic-storage power station based on electricity, green certificate, and carbon price prediction according to claim 5, wherein an expression of the second objective function is:
$$max [ \begin{matrix}{\sum }_{∀ t , ∀ x} {ξ}_{x} {\sum }_{k} {p}_{k , t}^{A} ( {λ}_{t , x}^{e} - {λ}_{k , t}^{A} ) Δ t + \\ {\sum }_{∀ x} {ξ}_{x} {λ}_{x}^{g} ( {\sum }_{∀ t} {a}_{w , t} {p}_{w , t} + {\sum }_{∀ t} {a}_{pv , t} {p}_{pv , t} ) Δ t\end{matrix} ]$$
wherein ξₓ is a weight of an x-th type of price scenario;
$${λ}_{t , x}^{e}$$
is an electricity price at the time t under the x-th type of price scenario;
$${λ}_{x}^{g}$$
is a green certificate price under the x-th type of price scenario; a_{w,t} is a green certificate allocation coefficient of the wind turbine unit; and a_{pv,t} is a green certificate allocation coefficient of the photovoltaic unit;
the second constraint condition is:
$$\{ \begin{matrix}0 \leq {p}_{pv , t} \leq {p}_{pv , t}^{ipre} \leq {P}_{pv , t}^{N} \\ 0 \leq {p}_{w , t} \leq {p}_{w , t}^{ipre} \leq {P}_{w , t}^{N}\end{matrix} ;$$
$$\{ \begin{matrix}{P}_{ess , min} \leq {P}_{ess , t}^{i n} , {P}_{e ss , t}^{out} \leq {P}_{ess , max} \\ {P}_{ess , t}^{out} \times {P}_{ess , t}^{i n} = 0 \\ So {C}_{ess , t} = S o {C}_{ess , t - 1} + \frac{[ {η}_{ess , in} {P}_{ess , t}^{in} - {P}_{ess , t}^{out} / {η}_{ess , out} ]}{{E}_{ess}^{N}} \\ So {C}_{ess , min} \leq S o {C}_{ess , t} \leq S o {C}_{ess , max}\end{matrix}$$
wherein
$${p}_{pv , t}^{ipre}$$
is a predicted output of the photovoltaic unit at the time t,
$${P}_{pv , t}^{N}$$
is an installed capacity of the photovoltaic unit at the time t;
$${p}_{w , t}^{ipre}$$
is a predicted output or the wind turbine unit at the time t; and
$${P}_{w , t}^{N}$$
is an installed capacity or the wind turbine unit at the time t; P_{ess,min} is a minimum charging/discharging power of the electrochemical energy storage system; P_{ess,max} is a maximum charging/discharging power of the electrochemical energy storage system; SoC_{ess,t} is a state of charge of the electrochemical energy storage system; SoC_{ess,min} is a lower limit of the state of charge of the electrochemical energy storage system; SoC_{ess,max} is an upper limit of the state of charge of the electrochemical energy storage system; η_{ess,in} is charging efficiency of the electrochemical energy storage system; η_{ess,out} is discharging efficiency of the electrochemical energy storage system; and
$${E}_{e s s}^{N}$$
is rated energy of the electrochemical energy storage system.

7. The method for regulating a wind-photovoltaic-storage power station based on electricity, green certificate, and carbon price prediction according to claim 6, wherein an expression of the third objective function is:
$$max [ {\sum }_{∀ t , ∀ x} {ξ}_{x} ( {\sum }_{∀ k} {p}_{k , t}^{G} ( {λ}_{t , x}^{e} - {λ}_{k , t}^{G} ) ) Δ t + {\sum }_{∀ x} {ξ}_{x} {λ}_{x}^{c o} ( {X}^{z i} - {\sum }_{∀ t} {b}_{g , t} {p}_{g , t} ) Δ t ]$$
$${b}_{g , t} = \{ \begin{matrix}{b}_{coal , t} , {p}_{g}^{m i n} \leq {p}_{g , t} \leq {p}_{g}^{m ax} \\ {b}_{coal , t} + {b}_{loss , t} , {p}_{g}^{A} \leq {p}_{g , t} \leq {p}_{g}^{m i n} \\ {b}_{coal , t} + {b}_{loss , t} + {b}_{oil , t} , {p}_{g}^{B} \leq {p}_{g , t} \leq {p}_{g}^{A}\end{matrix}$$
wherein
$${λ}_{x}^{c o}$$
is a carbon price under the x-th type of price scenario; X^{zi} is an initial carbon quota within a dispatch period; b_{g,t} is a total carbon emission factor of the thermal power unit at the time t; b_{coal,t} is a coal consumption carbon emission factor of the thermal power unit at the time t; b_{loss,t} is a loss carbon emission factor of the thermal power unit at the time t; b_{oil,t} is an oil injection carbon emission factor of the thermal power unit at the time t;
$${p}_{g}^{m i n}$$
is a lower limit output of the thermal power unit in a normal peak shaving stage;
$${p}_{g}^{m ax}$$
an upper limit output of the thermal power unit in the normal peak shaving stage;
$${p}_{g}^{A}$$
is a lower limit output of the thermal power unit in a stage of peak shaving through speed reduction; and
$${p}_{g}^{B}$$
is a lower limit output of the thermal power unit in a stage of peak shaving with oil injection; the third constraint condition is:
$$\{ \begin{matrix}{P}_{g}^{m i n} \leq {p}_{g , t} \leq {P}_{g}^{m ax} \\ {p}_{g , t} - {p}_{g , t - 1} \leq {P}_{g}^{u p} \\ {p}_{g , t - 1} - {p}_{g , t} \leq {P}_{g}^{d o w n}\end{matrix}$$
wherein
$${P}_{g}^{m i n}$$
is a minimum technical output of the thermal power unit,
$${P}_{g}^{ma x}$$
is a maximum technical output of the thermal power unit;
$${P}_{g}^{up}$$
is an upward ramp power limit of the thermal power unit; and
$${P}_{g}^{down}$$
is a downward lamp power limit of the thermal power unit.

8. A computer device, comprising: a memory, a processor and a computer program stored in the memory and executable on the processor, wherein the processor executes the computer program to implement the method for regulating a wind-photovoltaic-storage power station based on electricity, green certificate, and carbon price prediction according to claim 1.

9. A non-transitory computer-readable storage medium, wherein the computer-readable storage medium stores a computer program, and the computer program, when executed by a processor, implements the method for regulating a wind-photovoltaic-storage power station based on electricity, green certificate, and carbon price prediction according to claim 1.

10. The computer device according to claim 8, wherein the hybrid attention mechanism-based LSTM neural network model comprises a convolutional neural network, a sequential convolution attention module (SCAM), and an LSTM recurrent neural network that are connected sequentially.

11. The computer device according to claim 10, wherein a training process of the price prediction model comprises:
acquiring a training dataset;
inputting the training dataset into the hybrid attention mechanism-based LSTM neural network model, and outputting the prediction value of the sample price data; and
constructing a loss function based on the prediction value of the sample price data and a true value of the sample price data, and iteratively optimizing model parameters of the hybrid attention mechanism-based LSTM neural network model according to the loss function until an iteration count reaches a maximum value or the loss function reaches a minimum value, stopping the iterative optimization, and obtaining the price prediction model.

12. The computer device according to claim 8, wherein an expression of the uncertainty set of the predicted price is:
$$U ( D ) = \{ v \vert {\sum }_{i = 1}^{N} {α}_{i}^{*} {\sum }_{m = 1}^{M} {ε}_{m}^{*} {K}_{m} ( v , {v}_{i} ) \geq {p}^{*} \}$$
wherein U(D) is the uncertainty set of the predicted price; v is an uncertainty vector of the predicted price; αᵢ* is an optimized value of an i-th dual variable in α; εₘ* is an optimized value of an m-th kernel function coefficient; Kₘ (v, vᵢ) is a value of an m-th kernel function between the uncertainty vector v of the predicted price and a sample vᵢ; and p* is an optimized value of a bias term.

13. The computer device according to claim 8, wherein an expression of the first objective function is:
$$min {\sum }_{∀ k , ∀ t} ( {λ}_{k , t}^{A} {p}_{k , t}^{A} + {λ}_{k , t}^{G} {p}_{k , t}^{G} )$$
wherein
$${λ}_{k , t}^{A}$$
is a quotation of a k-th segment of the wind-photovoltaic-storage power station at time t;
$${p}_{k , t}^{A}$$
is an output active power of the k-th segment of the wind-photovoltaic-storage power station at the time t;
$${λ}_{k , t}^{G}$$
is a quotation of a k-th segment of the thermal power unit at the time t; and
$${p}_{k , t}^{G}$$
is an output active power of the k-th segment of the thermal power unit at the time t;
the first constraint condition is:
$${\sum }_{∀ g} {p}_{g , t} + {\sum }_{∀ w} {p}_{w , t} + {\sum }_{∀ p v} {P}_{pv , t} + {\sum }_{∀ e s s} ( {p}_{ess , t}^{out} - {p}_{ess , t}^{i n} ) = {\sum }_{∀ l} {p}_{l , t}$$
wherein p_{g,t} is an actual output of the thermal power unit at the time t; p_{w,t} is an output active power of a wind turbine unit at the time t; p_{pv,t} is an output active power of a photovoltaic unit at the time t;
$${p}_{e ss , t}^{out}$$
is a discharge power of an electrochemical energy storage system;
$${p}_{ess , t}^{i n}$$
is a changing power of th electrochemical energy storage system; and p_{l,t} is an electrical load demand.

14. The computer device according to claim 13, wherein an expression of the second objective function is:
$$max [ {\sum }_{∀ t , ∀ x} {ξ}_{x} ( {\sum }_{k} {p}_{k , t}^{A} ( {λ}_{t , x}^{e} - {λ}_{k , t}^{A} ) ) Δ t + {\sum }_{∀ x} {ξ}_{x} {λ}_{x}^{g} ( {\sum }_{∀ t} {a}_{w , t} {p}_{w , t} + {\sum }_{∀ t} {a}_{pv , t} {p}_{pv , t} ) Δ t ]$$
wherein ξₓ is a weight of an x-th type of price scenario;
$${λ}_{t , x}^{e}$$
is an electricity price at the time t under the x-th type of price scenario;
$${λ}_{x}^{g}$$
is a green certificate price under the x-th type of price scenario; a_{w,t} is a green certificate allocation coefficient of the wind turbine unit; and a_{pv,t} is a green certificate allocation coefficient of the photovoltaic unit;
the second constraint condition is:
$$\{ \begin{matrix}0 \leq {p}_{pv , t} \leq {p}_{pv , t}^{ipre} \leq {P}_{pv , t}^{N} \\ 0 \leq {p}_{w , t} \leq {p}_{w , t}^{ipre} \leq {P}_{w , t}^{N}\end{matrix} ;$$
$$\{ \begin{matrix}{P}_{ess , m i n} \leq {P}_{ess , t}^{i n} , {P}_{ess , t}^{out} \leq {P}_{ess , m ax} \\ {P}_{ess , t}^{out} \times {P}_{ess , t}^{i n} = 0 \\ {SoC}_{ess , t} = {SoC}_{ess , t - 1} + \frac{[ {η}_{ess , i n} {P}_{ess , t}^{i n} - {P}_{ess , t}^{out} / {η}_{ess , out} ]}{{E}_{ess}^{N}} \\ {SoC}_{ess , m i n} \leq {SoC}_{ess , t} \leq {SoC}_{ess , m ax}\end{matrix}$$
wherein
$${p}_{pv , t}^{ipre}$$
is a predicted output of the photovoltaic unit at the time t;
$${P}_{pv , t}^{N}$$
is an installed capacity of the photovoltaic unit at the time t;
$${p}_{w , t}^{ipre}$$
is a predicted output of the wind turbine unit at the time t; and
$${P}_{w , t}^{N}$$
is an installed capacity of the wind turbine unit at the time t; P_{ess,min} is a minimum charging/discharging power of the electrochemical energy storage system; P_{ess,max} is a maximum charging/discharging power of the electrochemical energy storage system; SoC_{ess,t} is a state of charge of the electrochemical energy storage system; SoC_{ess,min} is a lower limit of the state of charge of the electrochemical energy storage system; SoC_{ess,max} is an upper limit of the state of charge of the electrochemical energy storage system; η_{ess,in} is charging efficiency of the electrochemical energy storage system; η_{ess,out} is discharging efficiency of the electrochemical energy storage system; and
$${E}_{ess}^{N}$$
is rated energy of the electrochemical energy storage system.

15. The computer device according to claim 14, wherein an expression of the third objective function is:
$$max [ \begin{matrix}{\sum }_{∀ t , ∀ x} {ξ}_{x} {\sum }_{∀ k} {p}_{k , t}^{G} ( {λ}_{t , x}^{e} - {λ}_{k , t}^{G} ) Δt + \\ {\sum }_{∀ x} {ξ}_{x} {λ}_{x}^{c o} ( {X}^{z i} - {\sum }_{∀ t} {b}_{g , t} {p}_{g , t} Δ t\end{matrix} ]$$
$${b}_{g , t} = \{ \begin{matrix}{b}_{coal , t} , {p}_{g}^{min} \leq {p}_{g , t} \leq {p}_{g}^{max} \\ {b}_{coal , t} + {b}_{loss , t} , {p}_{g}^{A} \leq {p}_{g , t} \leq {p}_{g}^{min} \\ {b}_{coal , t} + {b}_{loss , t} + {b}_{oil , t} , {p}_{g}^{B} \leq {p}_{g , t} \leq {p}_{g}^{A}\end{matrix}$$
wherein
$${λ}_{x}^{c o}$$
is a carbon price under the x-th type of price scenario; X^{zi} is an initial carbon quota within a dispatch period; b_{g,t} is a total carbon emission factor of the thermal power unit at the time t; b_{coal,t} is a coal consumption carbon emission factor of the thermal power unit at the time t; b_{loss,t} is a loss carbon emission factor of the thermal power unit at the time t; b_{oil,t} is an oil injection carbon emission factor of the thermal power unit at the time t;
$${p}_{g}^{min}$$
is a lower limit output of the thermal power unit in a normal peak shaving stage;
$${p}_{g}^{max}$$
an upper limit output of the thermal power unit in the normal peak shaving stage;
$${p}_{g}^{A}$$
is a lower limit output of the thermal power unit in a stage of peak shaving through speed reduction; and
$${p}_{g}^{B}$$
is a lower limit output of the thermal power unit in a stage of peak shaving with oil injection; the third constraint condition is:
$$\{ \begin{matrix}{P}_{g}^{min} \leq {p}_{g , t} \leq {P}_{g}^{max} \\ {p}_{g , t} - {p}_{g , t - 1} \leq {P}_{g}^{up} \\ {p}_{g , t - 1} - {p}_{g , t} \leq {P}_{g}^{down}\end{matrix}$$
wherein
$${P}_{g}^{min}$$
is a minimum technical output of the thermal power unit;
$${P}_{g}^{up}$$
is a maximum technical output of the thermal power unit;
$${P}_{g}^{max}$$
is an upward ramp power limit of the thermal power unit; and
$${P}_{g}^{down}$$
is a downward ramp power limit of the thermal power unit.

16. The non-transitory computer-readable storage medium according to claim 9, wherein the hybrid attention mechanism-based LSTM neural network model comprises a convolutional neural network, a sequential convolution attention module (SCAM), and an LSTM recurrent neural network that are connected sequentially.

17. The non-transitory computer-readable storage medium according to claim 16, wherein a training process of the price prediction model comprises:
acquiring a training dataset;
inputting the training dataset into the hybrid attention mechanism-based LSTM neural network model, and outputting the prediction value of the sample price data; and
constructing a loss function based on the prediction value of the sample price data and a true value of the sample price data, and iteratively optimizing model parameters of the hybrid attention mechanism-based LSTM neural network model according to the loss function until an iteration count reaches a maximum value or the loss function reaches a minimum value, stopping the iterative optimization, and obtaining the price prediction model.

18. The non-transitory computer-readable storage medium according to claim 9, wherein an expression of the uncertainty set of the predicted price is:
$$U ( D ) = \{ v \vert {\sum }_{i = 1}^{N} {α}_{i}^{*} {\sum }_{m = 1}^{M} {ε}_{m}^{*} {K}_{m} ( v , {v}_{i} ) \geq {p}^{*} \}$$
wherein U(D) is the uncertainty set of the predicted price; v is an uncertainty vector of the predicted price; αᵢ* is an optimized value of an i-th dual variable in α; εₘ*is an optimized value of an m-th kernel function coefficient; Kₘ (v, vᵢ) is a value of an m-th kernel function between the uncertainty vector v of the predicted price and a sample vᵢ; and p* is an optimized value of a bias term.

19. The non-transitory computer-readable storage medium according to claim 9, wherein an expression of the first objective function is:
$$min {\sum }_{∀ k , ∀ t} ( {λ}_{k , t}^{A} {p}_{k , t}^{A} + {λ}_{k , t}^{G} {p}_{k , t}^{G} )$$
wherein
$${λ}_{k , t}^{A}$$
is a quotation of a k-th segment of the wind-photovoltaic-storage power station at time t;
$${p}_{k , t}^{A}$$
is an output active power of the k-th segment of the wind-photovoltaic-storage power station at the time t;
$${λ}_{k , t}^{G}$$
is a quotation of a k-th segment of the thermal power unit at the time t; and
$${p}_{k , t}^{G}$$
is an output active power of the k-th segment of the thermal power unit at the time t;
the first constraint condition is:
$${\sum }_{∀ g} {p}_{g , t} + {\sum }_{∀ w} {p}_{w , t} + {\sum }_{∀ p v} {p}_{pv , t} + {\sum }_{∀ e s s} ( {p}_{ess , t}^{out} - {p}_{ess , t}^{i n} ) = {\sum }_{∀ l} {p}_{l , t}$$
wherein p_{g,t} is an actual output of the thermal power unit at the time t; p_{w,t} is an output active power of a wind turbine unit at the time t; p_{pv,t} is an output active power of a photovoltaic unit at the time t;
$${p}_{e ss , t}^{out}$$
is a discharge power of an electrochemical energy storage system;
$${p}_{ess , t}^{i n}$$
is a changing power of the electrochemical energy storage system; and p_{l,t} is an electrical load demand.

20. The non-transitory computer-readable storage medium according to claim 19, wherein an expression of the second objective function is:
$$max [ {\sum }_{∀ t , ∀ x} {ξ}_{x} ( {\sum }_{k} {p}_{k , t}^{A} ( {λ}_{t , x}^{e} - {λ}_{k , t}^{A} ) Δ t + {\sum }_{∀ x} {ξ}_{x} {λ}_{x}^{g} ( {\sum }_{∀ t} {a}_{w , t} {p}_{w , t} + {\sum }_{∀ t} {a}_{pv , t} {p}_{pv , t} ) Δ t ]$$
wherein ξₓ is a weight of an x-th type of price scenario;
$${λ}_{t , x}^{e}$$
is a electricity price at the time t under the x-th type of price scenario;
$${λ}_{x}^{g}$$
is a green certificate price under the x-th type of price scenario; a_{w,t} is a green certificate allocation coefficient of the wind turbine unit; and a_{pv,t} is a green certificate allocation coefficient of the photovoltaic unit;
the second constraint condition is:
$$\{ \begin{matrix}0 \leq {p}_{pv , t} \leq {p}_{pv , t}^{ipre} \leq {P}_{pv , t}^{N} \\ 0 \leq {p}_{w , t} \leq {p}_{w , t}^{ipre} \leq {P}_{w , t}^{N}\end{matrix} ;$$
$$\{ \begin{matrix}{P}_{ess , m i n} \leq {P}_{ess , t}^{i n} , {P}_{ess , t}^{out} \leq {P}_{ess , m ax} \\ {P}_{ess , t}^{out} \times {P}_{ess , t}^{i n} = 0 \\ {SoC}_{ess , t} = {SoC}_{ess , t - 1} + \frac{[ {η}_{ess , i n} {P}_{ess , t}^{i n} - {P}_{ess , t}^{out} / {η}_{ess , out} ]}{{E}_{ess}^{N}} \\ {SoC}_{ess , m i n} \leq {SoC}_{ess , t} \leq {SoC}_{ess , m ax}\end{matrix}$$
wherein
$${p}_{pv , t}^{ipre}$$
is a predicted output of the photovoltaic unit at the time t;
$${P}_{pv , t}^{N}$$
is an installed capacity of the photovoltaic unit at the time t;
$${p}_{w , t}^{ipre}$$
is a predicted output of the wind turbine unit at the time t; and
$${P}_{w , t}^{N}$$
is an installed capacity of the wind turbine unit at the time t; P_{ess,min} is a minimum charging/discharging power of the electrochemical energy storage system; P_{ess,max} is a maximum charging/discharging power of the electrochemical energy storage system; SoC_{ess,t} is a state of charge of the electrochemical energy storage system; SoC_{ess,min} is a lower limit of the state of charge of the electrochemical energy storage system; SoC_{ess,max} is an upper limit of the state of charge of the electrochemical energy storage system; η_{ess,in} is charging efficiency of the electrochemical energy storage system; η_{ess,out} is discharging efficiency of the electrochemical energy storage system; and
$${E}_{e s s}^{N}$$
is rated energy of the electrochemical energy storage system.
